(19) United States
(12) Patent Application Publication
(10) Pub. No.: US 2006/0243379 A1
(43) Pub. Date: Nov. 2, 2006

(54) Method and apparatus for lamination by electron beam irradiation

(75) Inventors: William R. Livesay, San Diego, CA (US); Scott M. Zimmermann, Baskin Ridge, NJ (US); Chad R. Livesay, Encinitas, CA (US); Richard L. Ross, Del Mar, CA (US)

Correspondence Address: William Propp, Esq.;e-Beam & Light, Inc., Suite 233, 9747 Businesspark Avenue, San Diego, CA, 92131, US

(73) Assignee: e-Beam & Light, Inc.

(21) Appl. No.: 11/118,930

(22) Filed: Apr. 29, 2005

(51) Int. Cl. B32B 37/00

(52) U.S. Cl. 156/272.2; 156/379.6

(57) ABSTRACT

A method and appartus for directly laminating a first conductive or insulating layer to a second insulating layer includes electron beam irradiation through the first layer to the interface between the first layer and the second layer. The electron beam irradiation bonds the two layers together without an adhesive or other intermediate layer. The method and apparatus utilizes an electron beam exposure system in a soft vacuum environment. Heat from the electron beam irradiation or from a separate heating element accelerates and increases the lamination of the first and second layers.

### BACKGROUND OF INVENTION

The lamination of conductors (metals) with non-conductors (insulators) is a common practice used in the electronic industry to create interconnects in the manufacture of circuit boards, integrated circuits, multichip modules, etc. In addition, thin metal films, which are highly reflective, are coated onto glass or plastic, where they are used in optical devices, such as mirrors, lamp housings, and etcetera.

There are several methods for joining two materials together using conventional means; glue, adhesives, hot pressing, melting one material onto one another. Other techniques known to those of ordinary skill in the art are coating, plating, chemical vapor deposition, evaporation, painting, plasma discharge coating, sputtering, thermal bonding, and etcetera.

A common lamination technique is to use an intermediary layer of an adhesive between the metal and the insulator. However, some materials have surface properties, which make them difficult to join to other materials. Fluoropolymers are one such set of materials. Fluoropolymer materials and other materials have surface characteristics, which repel attachment to other materials. Their tribilogical properties are such that they are often used for non-stick surfaces and, as such, are difficult to join to other materials.

Fluoropolymer materials and other materials also have other properties which are highly desirable for use in electronic and optical applications. However, for fluoropolymer materials to be used in these applications requires that they can be laminated to other layers of other materials. For example, polytetrafluoroethylene has highly reflective properties and can be used as a diffused reflector in optical applications, e.g. backlight reflector for cell phones and LCD displays. Further, as shown in U.S. Pat. No. 6,164,789, the reflectivity of these materials may be improved by laminating to a specular layer (e.g. metal film).

Other applications for fluoropolymers are as an insulating dielectric for integrated circuits and printed circuit boards. With a low dielectric constant, fluoropolymers are highly desirable as insulating layers between metal interconnect patterns due to their low loss characteristics in high frequency circuit applications. Many attempts have been made to laminate copper interconnect layers onto fluoropolymer substrates without much success. The surface tribilogy of the fluoropolymer prevents good adhesion of metallic or conductive layers to these materials.

Materials that have high diffuse reflectivity or desirable dielectric properties include polytetrafluoroethylene (PTFE) film from Furon or E. I. Du Pont de Nemours & Co., DRP (a microporous structure of expanded polytetrafluoroethylene) manufactured by W. L. Gore and Associates, Spectralon from Labsphere, Inc., etc. Materials that have high (i.e. greater than 90% reflectance) specular reflectivity include Silverlux™, a product of 3M, aluminum, gold, and silver. Although these and other fluoropolymer films such as flourinated ethylene—propylene (FEP) may be improved for useful purposes by combining (laminating) with metal films or other fluropolymers, they have not been generally used in those applications due to the difficulty of bonding other layers such as metals to these materials.

Metal films applied to the surfaces of these fluropolymer materials by evaporation or sputtering will form weakly adherent bonds that can be readily peeled off the surface of the fluoropolymer material. Adhesives can sometimes be used to bond metals to the fluoropolymer materials, however, the addition of the adhesive can interfere or degrade the desired performance of the resulting lamination for its intended use.

Another technique, mechanical interlocking (typically called tooth) is also used to bond metallic layers to polymer systems. Not only does this require additional processing steps and cost to create the micro-roughness, the resulting tooth leads to a degradation of high frequency performance when used in a circuit board application. This tooth also limits the resolution of the circuit lines due to the thickness variations which result.

In U.S. Pat. No. 6,164,789, it is shown that combining a diffuse reflective material with a specular reflective layer may provide a higher reflectivity than the diffuse reflective material by itself. To bond metallic films to optically useful materials typically requires a third intermediary adhesive material. However, the addition of the adhesive material can compromise the performance of the resulting lamination. For optical applications, if the adhesive layer does not closely match the index of refraction of the diffuse reflective layer, Fresnel reflection losses will occur to light transmitting between layers. Further, the optical absorption of the adhesive layer can alter the optical spectra and further decrease the light output from the lamination. This optical spectra alteration and decreased light output is especially true in the near UV regions due to strong absorption of carbon hydrogen (CH) based adhesive systems. With the advent of high efficiency UV LEDs, the need for improved reflector materials and lamination techniques is apparent.

In the cases of adhesive or thermal bonding, some form of pressure must be applied to layers. This step typically involves expensive mechanical or hydraulic presses. Economical manufacturing requires large batches of materials. The typical manufacturing cycle time can be several minutes to several hours. In most cases, very high pressures and even vacuum assists are used. However, high pressure pressing on porous reflective or dielectric materials will cause compression of the nanoporous air pockets of the material, which will adversely affect the high reflectance or dielectric constant of the materials.

Even in vapor deposition approaches, typical activation methods required to enhance adhesion of metals tend also to degrade the reflective nature of the material. Clearly, there is a need for an improved method of joining metal layers to fluoropolymer and other dielectric substrates that does not require an intermediary adhesive or that compromises the performance of the laminate.

Prior art techniques utilized for bonding two materials without using adhesives include bombarding the interface between two materials with low energy (a few keV per atomic mass unit of the material being bombarded) ions, which cause the two materials to intermix and form usable bonds.

However, low energy ion bombardment can cause sputtering and can result in physical disruption of the film. In addition, the beam particles have a short path after reaching the interface resulting in contamination or doping of one or the other of the materials at the interface. Low energy ion beams are also limited to use with only very thin layers of material. This method is also limited to treating small surface areas, and is not capable of bonding metal films to certain industrially important insulator substrates such as ferrites, quartz, polyethylene or Teflon (polytetrafluoroethylene).

Another prior art technique that has been tried, U.S. Pat. No. 4,457,972 and U.S. Pat. No. 4,526,624, utilizes high energy (several hundred keV/amu) ion bombardment of a bond interface between two dissimilar materials. In this technique, high energy ions penetrate much deeper into a solid, which allows this technique to be used with thick films while minimizing doping effects at the interface. The high energy beam does not sputter away the metallic film while the low energy beam does. However, although a high energy beam of ions does not disrupt a metallic layer as violently as a low energy one, it still physically disrupts the films being irradiated.

In all of these prior art ion beam bombardment techniques, the ions can physically alter the properties of the films under bombardment causing a deterioration of the desirable properties of the film for its intended use. Whereas many of the fluoropolymers mentioned previously have desirable optical and/or electrical properties, they have not enjoyed widespread use in many applications due to the difficulty of these prior art techniques with bonding metallic films. Clearly there is a need for a simple, efficient and effective method of attaching various dielectric and metallic films without adhesives or altering the desirable properties of these films.

### SUMMARY OF THE INVENTION

According to the present invention, a method and appartus for directly laminating a first conductive or insulating layer to a second insulating layer includes electron beam irradiation through the first conductive or insulating layer to the interface between the first conductive or insulating layer and the second insulating layer. The first conductive layer can be a metal, a polymer, an oxide, a semiconductor, a glass, or a carbon. The first insulating layer can be a polymer, a fluoropolymer, silicon or glass. The second insulating layer can be a polymer, fluoropolymer, silicon or glass. The method and apparatus can directly laminate a first layer of an insulating material to a second layer of the same insulating material.

The electron beam source can be a large area electron beam source, a point electron beam source, a line electron beam source or a sweeping point, line or large area electron beam source.

The electron beam source is in a vacuum chamber having a soft vacuum between 5 and 80 milliTorr. The electron source irradiates the first conductive or insulating layer and the second insulating layer with an electron energy between 1 and 50 keV.

The electrons in the electron beam form an intermolecular bond between the first conductive or insulating layer and the second insulating layer at the interface between the first conductive or insulating layer and the second insulating layer. The first conductive or insulating layer is directly laminated to the second insulating layer across the entire interface of the first conductive or insulating layer and the second insulating layer.

Heat from the electron beam irradiation or from a separate heating element accelerates and increases the lamination of the first conductive or insulating layer and the second insulative layer.

An aperture mask on the first conductive or insulating layer allows for selective lamination of the first layer to the second insulating layer.

The electron beam exposure apparatus can continuously laminate a first conductive or insulating layer to a second insulating layer substrate as the two layers move past the electron beam source.

This method and apparatus requires no additional adhesive or any intermediate layer between the first conductive or insulating layer and the second insulating layer.

One embodiment of this invention is to attach a metallic film (e.g. aluminum, copper, silver, gold, etc.) to a fluoropolymer film for use as a diffuse, highly reflective film for optical applications.

Another embodiment of this invention is to laminate a metallic layer (e.g. copper) onto a fluoropolymer or other insulating material layer for use in printed circuit or microelectronic applications.

Multiple conductive or insulating layers can be directly laminated together.

Other aspects of the invention will become apparent from the following more detailed description, taken in conjunction with the accompanying drawings.

### DESCRIPTION OF DRAWINGS

The preferred embodiments of this invention will be described in detail, with reference to the following figures wherein:

FIG. 1 is a side view illustration of the electron beam exposure apparatus to directly laminate a first metallic conducting layer to a second fluropolymer insulating layer substrate.

FIG. 2 is an enlarged side view illustration of the electron beam exposure apparatus of FIG. 1 of the electrons incident on the first metal layer penetrating through to the interface between the first metal layer and the second fluoropolymer layer substrate with electron charging and ion generation.

FIG. 3 is a side view illustration of the electron beam exposure apparatus with an aperture mask to selectively laminate a first metallic conducting layer to a second fluropolymer insulating layer substrate.

FIG. 4 is a side view illustration of the electron beam exposure apparatus to continuously laminate a first metallic conducting layer to a second fluropolymer insulating layer substrate.

### DETAILED DESCRIPTION OF THE INVENTION

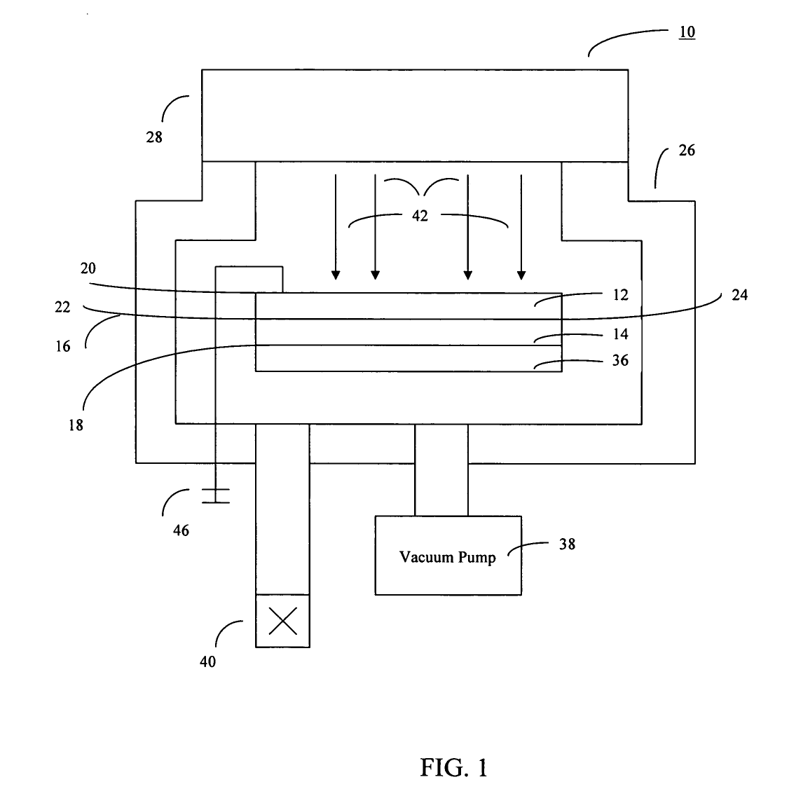

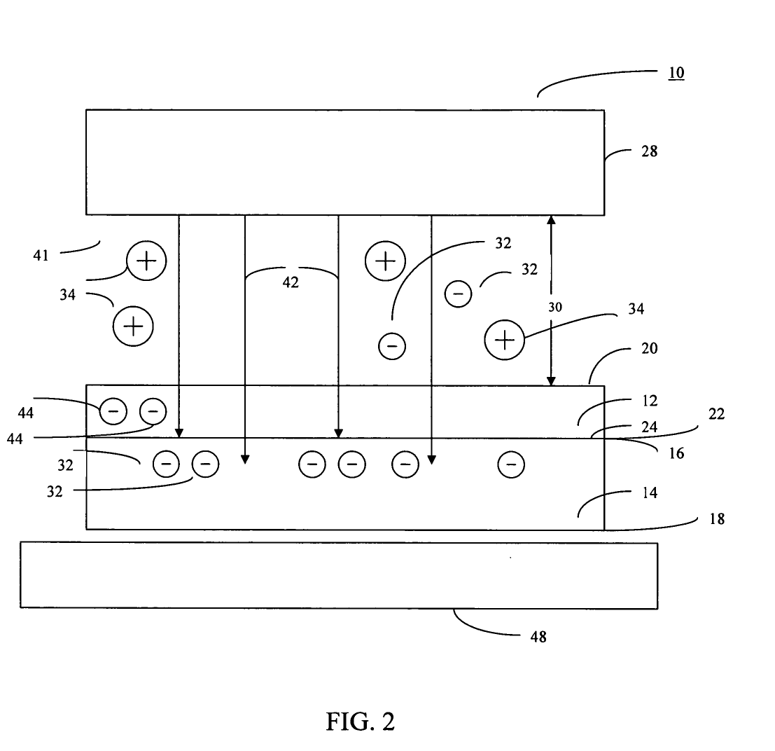

Reference is now made to FIG. 1 and FIG. 2 illustrating the electron beam exposure apparatus 10 to directly laminate a conductive or insulating layer 12 to an insulating layer 14 without an adhesive interlayer material or without an intermediate layer between the two layers. The insulating layer 14 will serve as the substrate for the laminate. The insulating material for the layer 14 can be a polymer, epoxy resin, thermo plastic, fluoropolymer, glass, or silicon.

For the purposes of the illustrative example of FIGS. 1 and 2, the insulating layer 14 is a fluoropolymer. A fluoropolymer is a polymer that contains fluorine atoms. An illustrative but not an exclusive list of examples of fluoropolymer suitable for this present invention are TFE tetrafluoroethylene, PPVE perfluoropropylvinyl ether, PTFE polytetrafluoroethylene, modified PTFE polytetrafluoroethylene, FEP fluoroethylene-propylene, FKM hexafluoropropylenevinylidenefluoride-copolymer, PFA perfluoralkoxy, ETFE ethylene-tetrafluoroethylene-copolymer, CTFE polychlorotrifluoroethylene, ECTFE ethylene-chlorotrifluoroethylene, PVDF polyvinylidene-fluoride, PVF polyvinyl-fluoride, PCTFE polychloro-trifluoroethylene, PEI polyetherimide, PSU polysulfone, PI polyimide, and PEEK polyetherketone.

The fluoropolymer layer substrate 14 has a first or upper surface 16 and a second or lower surface 18, opposite the first surface.

The conductive or insulating layer 12 is positioned on the insulating layer 14. The material for the layer 12 can be a conductive material, such as carbon (e.g. graphite), an oxide (e.g. indium tin oxide, zinc oxide, etc.), a polymer (e.g. iodine doped polyacetylene), or a metal. Alternatively, a semiconductor (e.g. silicon, galium nitride, galium arsenide, etc.) may also be used as layer 12, the first conductive material. An illustrative but not exclusive list of examples of metal layers suitable for this present invention are aluminum, copper, silver, titanium, platinum, nickel, tin, and gold. The material for the layer 12 can be an insulative material, such as the insulative material used in layer 14. An illustrative but not exclusive list of insulative materials suitable for this invention are a polymer, a polyimide, a fluoropolymer, thermo plastics, resins (e.g. epoxies), glass, or silicon.

For the purposes of the illustrative example of FIGS. 1 and 2, the conductive or insulating layer 12 is a metal conductive layer.

The metal layer 12 has a first or upper surface 20 and a second or lower surface 22, opposite the first surface.

The first surface 20 of the metal layer 12 does not require any prior treatment, such as etching or chemical wash, prior to electron beam irradiation.

The second or lower surface 22 of the metal layer 12 is positioned on the first or upper surface 16 of the fluoropolymer layer substrate 14. The second surface of the metal is in direct physical contact with the first surface of the fluoropolymer layer across the interface 24 between the two layers.

The fluropolymer layer substrate 14 with the metal layer 12 is placed in the vacuum chamber 26 of the electron beam exposure apparatus 10 depicted in FIG. 1. Now referring to FIG. 2, the substrate 14 and metal layer 12 is underneath the electron beam source 28 of the electron beam exposure apparatus 10 at a sufficient distance 30 from the electron beam source for the electrons 32 to generate ions 34 in their transit between the electron beam source 28 and the first upper surface 20 of the metal layer 12.

The second or lower surface 18 of the fluoropolymer layer substrate 14 can be positioned on a platen 36 as shown in FIG. 1 for support. Alternately, as shown in FIG. 2, the metallic layer 12 on the fluropolymer layer substrate 14 can be supported by itself.

As shown in FIG. 1, the electron beam exposure apparatus 10 includes the electron beam source 28, the vacuum chamber 26, a vacuum pump 38 attached to the vacuum chamber, and a variable leak valve or mass flow controller 40 for controlling the pressure and maintaining a supply of ambient gas 41 inside the vacuum chamber.

Once the fluropolymer layer substrate 14 with the metal layer 12 is placed in the vacuum chamber 26, the vacuum chamber is sealed and evacuated to a pressure of between 5 and 80 milliTorr by the vacuum pump 38. This pressure range is what is often called a soft vacuum. The exact pressure is controlled by the variable rate leak valve (or mass flow controller) 40, which is capable of controlling pressure to within 0.1 milliTorr.

The variable leak valve or mass flow controller 40 will also introduce a suitable ambient gas to the vacuum chamber to maintain the soft vacuum environment at a desired pressure.

The ambient gas 41 in the electron beam apparatus can be any of the following gases: nitrogen, oxygen, hydrogen, argon, xenon, helium, ammonia, silane, a blend of hydrogen and nitrogen, ammonia or any combination of these gases. A non-oxidizing atmosphere in the vacuum chamber is preferred for some metals (copper, aluminum) when bonding to the insulating polymer layer.

The electron beam source 28 will generate a uniform large area beam 42 of electron beam radiation which simultaneously covers the entire metal layer 12 on the fluropolymer layer substrate 14 which is spaced a distance 30 from the electron beam source. The large area electron beam source will work within and is compatible with a soft vacuum (5 to 80 millitorr) environment.

The electron beam source 28 can alternately be a line electron beam source or a point electron beam source. Again alternately, the electron beam source can sweep the electron beam across the full area of the first surface 20 of the metal layer 12. The sweeping electron beam source can be a point electron beam source, a line electron beam source or a full area electron beam source.

The electron beam source 28 can be a cold cathode gas discharge source with a grid anode; a glow discharge cathode with a grid anode; a charged particle source; or a large area thermionic cathode. Electron sources suited for this are described in U.S. Pat. Nos. 3,970,892 and 4,025,818.

Referring to FIG. 2, the substrate 14 and metal film 12 is placed underneath the electron source 28 at a distance 30 from the source sufficient for the electrons 32 to generate ions 34 in their transit between the source 28 and the surface 20 of the metal layer 12.

The electron beam source 28 will emit a uniform large area beam 42 of electrons 32 that is incident across the full area of the first surface 20 of the metal layer 12. The electrons 32 will penetrate the full thickness of the metal layer 12 to the interface 24 between the second surface of the metal layer 22 and the first surface 16 of the fluoropolymer layer substrate 14. The electrons irradiate the full metal layer 12, the interface 24 and the first surface 16 of the fluoropolymer layer substrate 14.

An electron energy (potential difference between the electron source 28 and the substrate 14) is selected to fully penetrate the thin metal layer 12 down to the fluoropolymer substrate 14. An electron energy between 1 and 50 keV may be used to irradiate the metal layer 12 and the interface 24. For example, an electron beam energy of 9 keV may be used to penetrate a thin metal film of 600 nanometer thickness. Higher electron beam energies are used for thicker metal layers and/or higher density metals. The range of electrons in metals and other materials is well known in the art and varies with the density and atomic number of the material.

The electrons 32 in the electron beam 42 form an intermolecular bond between the metal layer 12 and the fluoropolymer substrate 14 at the interface 24 between the second surface of the metal layer 22 and the first surface 16 of the fluoropolymer layer substrate 14. The metal layer 12 is directly laminated to the fluoropolymer substrate 14 across the entire interface 24 of the second surface 22 of the metal layer and the first surface 16 of the fluoropolymer layer substrate.

Referring to FIG. 2, emitted electrons 32 traversing the distance 30 between the electron beam source 28 and the metal layer 12 ionize the gas molecules located in the region between the electron beam source 28 and the metal layer 12 generating positive ions 34.

The metal layer 12 on the fluoropolymer substrate 14 will begin to charge negatively, as indicated at 44, under electron irradiation from the electron beam source. However, the positive ions 34 in the region near the metal layer surface 20 exposed to the soft vacuum will be attracted to this negative charge and the positive ions 34 will then neutralize the negative charge at the first surface 20 of the metal layer 12. These positive ions will combine with the electrons and neutralize any charge build-up in the metal layer 12, maintaining the metal layer 12 at close to ground potential.

Electrons 32 with trajectories incident on the upper conducting metal layer 12 will also pass through the metal layer and come to rest in the underlying insulating substrate 14. The fluoropolymer material of the substrate is an insulator and will begin to charge negatively, under electron irradiation.

The energy of the electron beam 42 is selected such that the electrons penetrate the metal layer to the interface of the metal layer and the fluoropolymer layer substrate. These low energy electrons 32 accumulate within the insulating fluoropolymer layer substrate 14 creating a very high electrostatic field. The metal layer 12 which is exposed to the vacuum ambient atmosphere is held near ground potential either by a contact electrode 46 shown in FIG. 1 or by positive ion bombardment. These positive ions are created naturally if the insulating material substrate is exposed in a soft vacuum (5 milliTorr to 80 milliTorr).

If a soft vacuum is not utilized, conventional electron sources using thermionic emitters may be used. Referring to FIG. 1, a separate electrode 46 can be electrically connected to the first surface 20 of the metal layer 12 to maintain the metal layer at or near ground potential for vacuum levels operating outside of a soft vacuum.

The insulating material of the layer substrate 14 can be a porous or non-porous material. A porous insulating material compresses when heat and pressure bonded to another material. Electron beam lamination will not ordinarily heat the underlying second layer 14. A porous insulating material used for the underlying second layer will not compress in bulk when laminated by the electron beam apparatus and method of the present invention.

Alternately, the irradiating electron beam 42 can provide (depending on its current densities) heating of the metal layer 12 and the fluoropolymer substrate 14 to enhance the lamination of the two layers.

Again alternately, the platen 36 can contain a heating element (either radiant or conductive) to increase and accelerate the lamination of the two layers as shown in FIG. 1. Again alternately, a separate heating element 48 can be provided adjacent to the second or lower surface 18 of the fluoropolymer layer substrate 14 to increase and accelerate the lamination of the two layers as shown in FIG. 2.

The combination of electron beam irradiation of the upper metal layer and substrate material and heat creates an heretofore unattainable bond between conductive materials, such as the metal layer, and difficult to bond, insulating dielectric materials, such as the fluoropolymer layer substrate, without the need for an adhesive layer or pretreatment of the surface of the metal layer, such as etching.

The present invention does not have an adhesive layer, a buffer layer, a transfer layer or an intermediate layer or layers between the two layers of dissimilar material to be laminated together. The two layers are directly laminated together.

In one embodiment of the invention, the substrate is simultaneously heated and irradiated by the electron beam throughout the entire process.

One particular advantage of the method described by this invention is that it enables the bonding of two materials without affecting the optical or electrical properties of at least one of the materials, the material in the second underlying layer. By adjusting the electron beam energy such that the electrons penetrate the top layer to be bonded and irradiate the interface between the two materials, the electrons only penetrate a very short distance into the underlying layer to be bonded. This electron beam method and apparatus minimizes degradation of the bulk optical or electrical properties of the underlying material.

This electron beam method and apparatus is particularly advantageous in fabricating a highly reflective laminate as has been described wherein the upper metal layer is penetrated by the electron beam, but the underlying optical layer (e.g. Avian Fluorofilm) is only exposed near the interface between the two materials. The bulk of the underlying optical material is not affected by the ionizing radiation of the electron beam and maintains its desirable optical properties (e.g. reflectivity).

In one of the preferred embodiments, the upper layer is metal and the lower layer is the polymer. The electrical and/or optical properties of a metal are not adversely affected by low energy (<50 kV) electron beam irradiation, therefore, the electron beam exposure is performed through the upper metal layer and only a minute distance into the bottom insulating layer. This allows two dissimilar materials to be bonded or laminated without affecting the optical or electrical properties of either material.

In its simplest form (as described above), a layer, such as a thin film of metal, is placed on top an insulator substrate and is subjected to low energy electron bombardment over the entire area of the film. The electrons penetrate to the interface between the two materials and result in adherence of the entire film to the substrate.

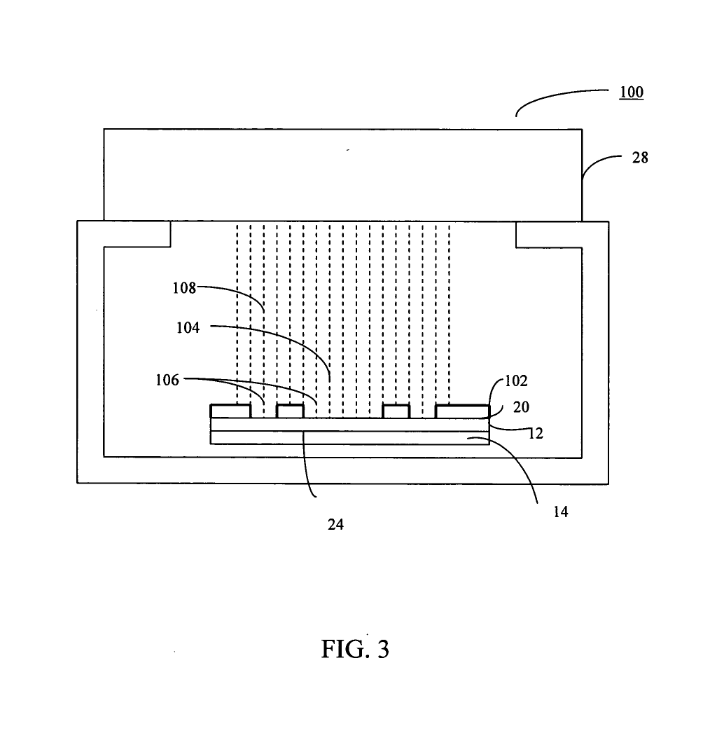

The electron beam exposure apparatus 100 of FIG. 3 is the same as the electron beam exposure apparatus 10 of FIGS. 1 and 2 except that a patterned aperture mask 102 is positioned between the electron source 28 and the first or upper surface 20 of the metal layer 12. The mask in this example is on the first surface of the metal layer but can alternately be anywhere in the electron beam path between the electron source and the first surface of the metal layer.

The electron beam source 28 will generate a uniform large area beam of electron beam radiation, which simultaneously covers the entire masked metal layer 12 on the fluropolymer layer substrate 14. In this embodiment, an electron source that generates a collimated or nearly collimated beam is preferred.

The mask 102 blocks the electrons 104 from the metal layer and the fluoropolymer layer substrate. Without the electron beam irradiation, the metal layer will not bond or laminate to the fluropolymer layer at the interface between the two layers.

The open apertures 106 of the mask 102 allow the electrons 108 to penetrate the full thickness of the metal layer 12 to the interface 24 between the second surface of the metal layer and the first surface of the fluoropolymer layer substrate 14. The electrons 104 irradiate the full metal layer, the interface and the first surface of the fluoropolymer layer substrate beneath the apertures of the mask. The metal layer will bond to the fluoropolymer substrate 14 at the interface 24 only in the areas 106 of electron beam radiation which is only the areas of the interface under the apertures of the mask.

Both the metal mask 102 and the metal film to be bonded are maintained at close to ground potential by the process previously described. The thickness of the metal mask is thick enough such that the electrons do not penetrate through the mask and reach the metal film below.

The non-irradiated areas of the metal layer 12 are easily removed to provide a firmly adherent pattern on the substrate 14. After the metal layer has been exposed with this patterned electron beam, the unwanted portions of the metal layer can be readily removed by mechanically scrubbing the metal off the insulating substrate. Alternatively, the unexposed and unwanted portions of the metal layer may be removed by immersing the substrate in an ultrasonic bath.

This embodiment of the present invention utilizes a patterned electron beam to expose selected areas of the first conductive or insulating layer thereby bonding the first conductive or insulating layer to the second insulating layer substrate only in the areas exposed by the electron beam.

Rather than a large area electron beam source which simultaneously covers the entire masked metal layer 12 on the fluropolymer layer substrate 14, the large area electron beam can sweep across the entire masked metal layer 12 on the fluropolymer layer substrate 14. Alternately, a point electron beam or a line electron beam from the appropriate electron beam source can sweep across the entire masked metal layer 12 on the fluropolymer layer substrate 14.

The apparatus and method of the mask of FIG. 3 provides selective lamination of the first conductive or insulating layer to the second insulating layer.

Rather than use a mask, the first conductive or insulating layer can be selectively laminated to the second insulating layer by a point electron beam from a point electron beam source or a line electron beam from a line electron beam source which only exposes selected areas of the first conductive or insulating layer. The first conductive or insulating layer will be laminated to the second insulating layer substrate only in the areas exposed by the electron beam.

The use of a sweeping electron beam source, whether a point electron beam source or a line electron beam source or a large area electron beam source, can also laminate selected areas of the first conductive or insulating layer to the second insulating layer substrate only in the areas exposed by the electron beam.

Another embodiment of the invention is attachment of metallic conductors to insulating films or substrates utilized for electronic interconnects in microelectronics or printed circuit board applications.

Low dielectric constant materials minimize coupling capacitance between interconnects. However, the use of fluorinated materials, which have inherently low dielectric constants, pose particular problems for adhering metal conductors to their surfaces. In fact, the widespread use of fluoropolymer materials in printed circuit board and microelectronic applications has been hampered by the difficulty in adhering common interconnect metals such as copper, gold, aluminum, silver, etc. to their surfaces.

With the technique described by this invention, copper and other popular metal interconnect materials may be easily bonded to fluoropolymer substrates and/or dielectric layers.

One method of using this process is to laminate a thin layer of metal (e.g. copper, gold, etc.) wherein the metal film is a thin foil covering the entire insulating fluoropolymer substrate. The thin metal layer is placed on top of the fluoropolymer substrate in the electron beam apparatus and exposed to the electron beam and, optionally, heated simultaneously, to bond the thin metal layer to the fluoropolymer substrate. The resulting laminated metal/fluoropolymer structure can then be patterned using conventional photolithography and etching techniques to form an interconnecting network and/or printed circuit board.

Alternately, the method and apparatus of FIG. 3 can selectively laminate the metal layer to the fluoropolymer substrate for printed circuit board and microelectronic applications. A major advantage of this method of forming patterned areas of metal on printed wiring or circuit board materials is that it is environmentally friendly. Typically, etching of copper clad materials involves wet chemical etching using toxic chemicals. In this new and novel method, there is no requirement for toxic chemicals. The e-beam process does not generate any toxic waste and the result of scrubbing the metal film (mechanically or untrasonically) produces only residual metal (e.g. copper) which can be easily reclamated.

In an illustrative example. a highly reflective flouropolymer layer was made even more reflective by electron beam lamination with a thin silver layer. A 0.5 by 0.75″ silver foil 0.5 μm thick was placed on top of a 100 μm thick fluorifilm. The electron beam was masked with a stainless steel template and exposed with the following conditions: 25 keV, 5-10 microamps/cm², 2500 μC/cm², 17 milliTorr. After the exposure, the silver layer was firmly bonded to the fluorifilm only in the areas exposed by the electron beam. The reflectivity of the laminated silver and fluorifilm as viewed from the fluorofilm side of the laminate was measured at 93-94% at 480 nm.

Satisfactory results also were obtained when bonding 100 micrometer thick fluorifilm to 4 micrometer thick Au/Al leaf film. Electron bombardment of the Au/Al film and fluorifilm sandwich with beams of 25 keV at 1.5-3.0 mA (7-15 microamps/cm²) and a dose of 500 μC/cm² while continuously heated to a temperature of 100° C. produced a strong bond of the two materials over the entire area irradiated by the electron beam.

Satisfactory results also were obtained when bonding 7 micrometer thick FEP to a silicon wafer. Electron bombardment of the FEP/silicon sandwich with beams of 30 keV at 2.0 mA (7-15 microamps/cm²) and a dose of 1000 μC/cm² at ambient temperature produced a strong bond of the two materials over the entire area irradiated by the electron beam.

The circuit board and the reflector can also be fabricated with a sweeping electron beam with a masked metal layer or by selective electron beam lamination with a line beam without a mask on the metal layer or a point beam without a mask on the metal layer, as discussed in the present application.

This present invention to laminate two similar or dissimilar materials using electron beam apparatus may be expanded for producing laminated films in high volume. This high volume electron beam lamination can be attained by passing the two materials to be bonded under a broad area or line source electron beam exposure apparatus.

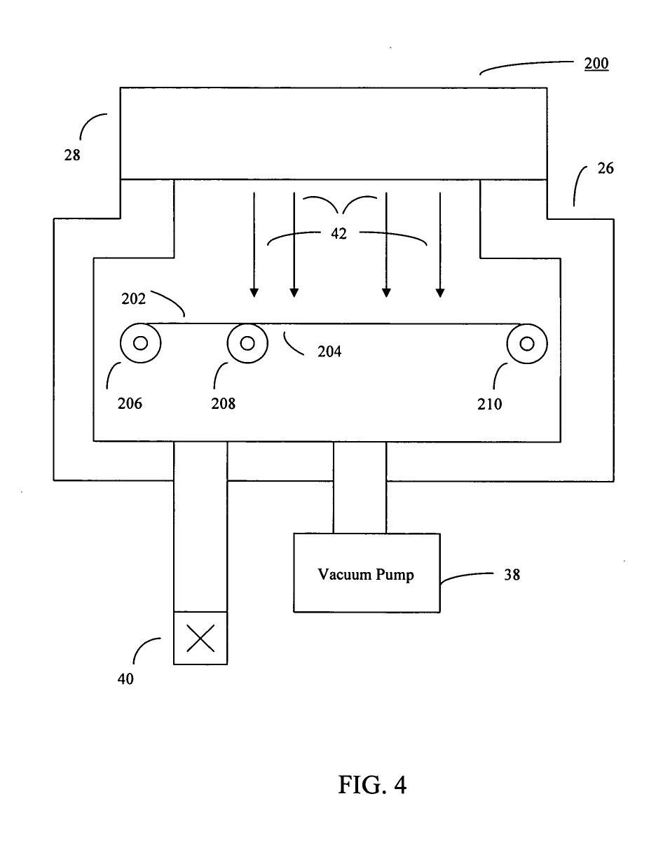

The electron beam exposure apparatus 200 in FIG. 4 will continuously laminate a metal conducting layer 202 to a fluoropolymer insulating layer substrate 204. The metal layer 202 will unspool from first roll 206 while the fluoropolymer layer 204 will unspool from second roll 208. The metal layer 202 is positioned on top of the fluoropolymer layer 204. The two layers are then passed through the electron beam 42 which laminates the metal layer to the fluoropolymer layer. The laminate will then be rolled onto a single spindle 210.

Alternatively, the two materials to be joined may be kept at atmosphere and passed under an electron beam, which is emitted through a thin electron permeable window. Other techniques and electron beam apparatus can be utilized with this method while staying in the scope of this invention.

The present invention is not limited to directly laminating a conductive or insulating layer to an insulating layer. Multiple conductive or insulating layers can be directly laminated together by the method and apparatus previously described in this invention.

A third conductive or insulating layer can be subsequently positioned on the laminate of the first conductive or insulating layer and the second insulating layer. The lower surface of the third conductive or insulating layer is positioned on the upper surface of the first conductive or insulating layer in direct physical contact across the interface between the two layers of the third conductive or insulating layer and the first conductive or insulating layer without an adhesive interlayer material or without an intermediate layer between those two layers. The two layer laminate will serve as the substrate for the three layer laminate. The upper surface of the third conductive or insulating layer does not require any prior treatment, such as etching or chemical wash, prior to electron beam irradiation.

The third conductive or insulating layer on the two layer laminate of the first conductive or insulating layer and the second insulating layer is placed in the vacuum chamber 26 of the electron beam exposure apparatus 10 depicted in FIG. 1. The vacuum chamber is then sealed and evacuated to a soft vacuum pressure of between 5 and 80 milliTorr by the vacuum pump 38.

The electron beam source 28 will generate a uniform large area beam 42 of electron beam radiation which simultaneously covers the entire third conductive or insulating layer on the two layer laminate of the first conductive or insulating layer and the second insulating layer which is spaced a distance 30 from the electron beam source. The electron beam source 28 can alternately be a line electron beam source or a point electron beam source. Again alternately, the electron beam source can sweep the electron beam across the full area of the upper surface of the third conductive or insulating layer. The sweeping electron beam source can be a point electron beam source, a line electron beam source or a full area electron beam source.

An electron energy (potential difference between the electron source 28 and the laminate) is selected to fully penetrate the third conductive or insulating layer down to the interface with the two layer laminate of the first conductive or insulating layer and the second insulating layer.

The electrons 32 in the electron beam 42 form an intermolecular bond between the third conductive or insulating layer and the laminate of the first conductive or insulating layer and the second insulating layer at the interface between the lower surface of the third conductive or insulating layer and the upper surface of the first conductive or insulating layer of the two layer laminate. The third conductive or insulating layer is directly laminated to the two layer laminate of the first conductive or insulating layer and the second insulating layer across the entire interface of the lower surface of the third conductive or insulating layer and the upper surface of the first conductive or insulating layer of the two layer laminate. The result is a three layer laminate.

A third conductive or insulating layer can be directly laminated to the two layer laminate of the first conductive or insulating layer and the second insulating layer using the masking method and apparatus of FIG. 3 and accompanying text or in the continuous lamination method and apparatus of FIG. 4 and accompanying text.

The third conductive or insulating layer can be positioned and directly laminated to the second insulating layer of the laminate of the first conductive or insulating layer and the second insulating layer. The lower surface of the third conductive or insulating layer is positioned on the lower surface of the second insulating layer of the two layer laminate of the first conductive or insulating layer and the second insulating layer and the lamination occurs along that interface.

Alternately, the third conductive or insulating layer can be positioned on the first conductive or insulating layer which is positioned on the second insulating layer. The first conductive or insulating layer can be directly laminated to the second insulating layer and the third conductive or insulating layer can be directly laminated to the first conductive or insulating layer contemporaneously by the method and apparatus previously described in this invention.

Beyond three layers of conductive or insulating materials, multiple conductive or insulating layers can be directly laminated by the method and apparatus previously described in this invention. Mutliple layer laminates can be used for reflective elements such as mirrors or distributed Bragg reflectors (DBR), with alternating layers of semiconductor material having different refractive indices, or multiple layered printed circuit boards.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A method of directly laminating a first layer of a first material to a second layer of a second material comprising the steps of:
positioning said first layer of said first material on said second layer of said second material; and
irradiating the surface of said first layer of said first material with an electron beam; said electron beam penetrating through said first layer of said first material to the interface between said first layer of said first material and said second layer of said second material; and said electron beam bonding said first layer of said first material to said second layer of said second material at said interface.

2. The method of directly laminating a first layer of a first material to a second layer of a second material of claim 1 wherein said irradiating the surface of said first layer of said first material with an electron beam is irradiating the entire surface said first layer of said first material simultaneously with a large area electron beam.

3. The method of directly laminating a first layer of a first material to a second layer of a second material of claim 1 wherein said irradiating the surface of said first layer of said first material is with a point electron beam.

4. The method of directly laminating a first layer of a first material to a second layer of a second material of claim 1 wherein said irradiating the surface of said first layer of said first material is with a line electron beam.

5. The method of directly laminating a first layer of a first material to a second layer of a second material of claim 1 wherein said irradiating the surface of said first layer of said first material with an electron beam is irradiating the entire surface said first layer of said first material with a electron beam sweeping across the entire surface said first layer of said first material.

6. The method of directly laminating a first layer of a first material to a second layer of a second material of claim 1 wherein said first material is different from said second material.

7. The method of directly laminating a first layer of a first material to a second layer of a second material of claim 1 wherein said first material is the same as said second material.

8. The method of directly laminating a first layer of a first material to a second layer of a second material of claim 1 wherein said irradiating with an electron beam is conducted in a soft vacuum environment.

9. The method of directly laminating a first layer of a first material to a second layer of a second material of claim 8 wherein said soft vacuum environment is between 5 and 80 milliTorr.

10. The method of directly laminating a first layer of a first material to a second layer of a second material of claim 1 wherein said irradiating with an electron beam is an electron energy between 1 and 50 keV.

11. The method of directly laminating a first layer of a first material to a second layer of a second material of claim 1 wherein said irradiating with an electron beam heats said metal layer and said fluropolymer layer accelerating and increasing said electron beam bonding said metal layer to said fluoropolymer layer at said interface.

12. The method of directly laminating a first layer of a first material to a second layer of a second material of claim 1 further comprising the step of:
positioning an aperture mask between said electron beam and said first layer such that said electron beam selectively irradiates a portion of said surface of said first layer underneath said aperture in said mask; said electron beam penetrating through said first layer to the interface between said first layer and said second layer, and said electron beam selectively bonding said first layer to said second layer at said interface underneath said aperture in said mask.

13. The method of directly laminating a first layer of a first material to a second layer of a second material of claim 1 further comprising the step of:
moving said first layer on said second layer while irradiating the surface of said first layer with an electron beam.

14. The method of directly laminating a first layer of a first material to a second layer of a second material of claim 1 wherein said irradiating the surface of said first layer of said first material with an electron beam is selectively irradiating a portion of said surface of said first layer of said first material with an electron beam; said electron beam penetrating through said first layer of said first material to the interface between said first layer of said first material and said second layer of said second material; and said electron beam selectively bonding a portion of said first layer of said first material to said second layer of said second material at said interface.

15. The method of directly laminating a first layer of a first material to a second layer of a second material of claim 14 further comprising the step of:
removing the portion of said first layer of said first material not selectively irradiated by said electron beam and not selectively bonded to said second layer of said second material at said interface.

16. The method of directly laminating a first layer of a first material to a second layer of a second material of claim 1 further comprising the step of:
positioning a third layer of a third material on said first layer of said first material; and
irradiating the surface of said third layer of said third material with an electron beam; said electron beam penetrating through said third layer of said third material to the interface between said third layer of said third material and said first layer of said first material; and said electron beam bonding said third layer of said third material to said first layer of said first material at said interface.

17. The method of directly laminating a first layer of a first material to a second layer of a second material of claim 16 further comprising the step of:
positioning an aperture mask between said electron beam and said third layer of said third material such that said electron beam selectively irradiates a portion of said surface of said third layer of said third material underneath said aperture in said mask; said electron beam penetrating through said third layer of said third material to the interface between said third layer of said third material and said first layer of said first material, and said electron beam selectively bonding said third layer of said third material to said first layer of said first material at said interface underneath said aperture in said mask.

18. The method of directly laminating a first layer of a first material to a second layer of a second material of claim 16 further comprising the step of:
moving said third layer of said third material on said first layer while irradiating the surface of said third layer of said third material with an electron beam.

19. A method of directly laminating a first conductive material layer to a second insulating material layer comprising the steps of:
positioning said first conductive material layer on said second insulating material layer; and
irradiating the surface of said first conductive material layer with an electron beam; said electron beam penetrating through said first conductive material layer to the interface between said first conductive material layer and said second insulating material layer; and said electron beam bonding said first conductive material layer to said second insulating material layer at said interface.

20. The method of directly laminating a first conductive material layer to a second insulating material layer of claim 19 wherein said irradiating the surface of said first conductive material layer with an electron beam is irradiating the entire surface said first conductive material layer simultaneously with a large area electron beam.

21. The method of directly laminating a first conductive material layer to a second insulating material layer of claim 19 wherein said irradiating the surface of said first conductive material layer is with a point electron beam.

22. The method of directly laminating a first conductive material layer to a second insulating material layer of claim 19 wherein said irradiating the surface of said first conductive material layer is with a line electron beam.

23. The method of directly laminating a first conductive material layer to a second insulating material layer of claim 19 wherein said irradiating the surface of said first conductive material layer with an electron beam is irradiating the entire surface said first conductive material layer with a electron beam sweeping across the entire surface said first conductive material layer.

24. The method of directly laminating a first conductive material layer to a second insulating material layer of claim 19 wherein said first conductive material is a metal and said second insulating material is a fluoropolymer.

25. The method of directly laminating a first conductive material layer to a second insulating material layer of claim 19 wherein said second insulating material is a porous insulator.

26. The method of directly laminating a first conductive material layer to a second insulating material layer of claim 19 wherein said irradiating with an electron beam is conducted in a soft vacuum environment.

27. The method of directly laminating a first conductive material layer to a second insulating material layer of claim 26 wherein said soft vacuum environment is between 5 and 80 milliTorr.

28. The method of directly laminating a first conductive material layer to a second insulating material layer of claim 19 wherein said irradiating with an electron beam is an electron energy between 1 and 50 keV.

29. The method of directly laminating a first conductive material layer to a second insulating material layer of claim 19 wherein said irradiating with an electron beam heats said first conductive material layer and said second insulating material layer accelerating and increasing said electron beam bonding said first conductive material layer to said second insulating material layer at said interface.

30. The method of directly laminating a first conductive material layer to a second insulating material layer of claim 19 further comprising the step of:
positioning an aperture mask between said electron beam and said first conductive material layer such that said electron beam selectively irradiates a portion of said surface of said first conductive material layer underneath said aperture in said mask; said electron beam penetrating through said first conductive material layer to the interface between said first conductive material layer and said second insulating material layer, and said electron beam selectively bonding said first conductive material layer to said second insulating material layer at said interface underneath said aperture in said mask.

31. The method of directly laminating a first conductive material layer to a second insulating material layer of claim 19 further comprising the step of:
moving said first conductive material layer on said second insulating material layer while irradiating the surface of said first conductive material layer with an electron beam.

32. The method of directly laminating a first conductive material layer to a second insulating material layer of claim 19 wherein said irradiating the surface of said first conductive material layer with an electron beam is selectively irradiating a portion of said surface of said first conductive material layer with an electron beam; said electron beam penetrating through said first conductive material layer to the interface between said first conductive material layer and said second insulating material layer; and said electron beam selectively bonding a portion of said first conductive material layer to said second insulating material layer at said interface.

33. The method of directly laminating a first conductive material layer to a second insulating material layer of claim 32 further comprising the step of:
removing the portion of said first conductive material layer not selectively irradiated by said electron beam and not selectively bonded to said second insulating material layer at said interface.

34. The method of directly laminating a first conductive material layer to a second insulating material layer of claim 19 further comprising the step of:
positioning a third conductive or insulating layer on said first conductive material layer; and
irradiating the surface of said third conductive or insulating layer with an electron beam; said electron beam penetrating through said third conductive or insulating layer to the interface between said third conductive or insulating layer and said first conductive material layer; and said electron beam bonding said third conductive or insulating layer to said first conductive material layer at said interface.

35. The method of directly laminating a first conductive material layer to a second insulating material layer of claim 34 further comprising the step of:
positioning an aperture mask between said electron beam and said third conductive or insulating layer such that said electron beam selectively irradiates a portion of said surface of said third conductive or insulating layer underneath said aperture in said mask; said electron beam penetrating through said third conductive or insulating layer to the interface between said third conductive or insulating layer and said first conductive layer, and said electron beam selectively bonding said third conductive or insulating layer to said first conductive layer at said interface underneath said aperture in said mask.

36. The method of directly laminating a first conductive material layer to a second insulating material layer of claim 34 further comprising the step of:
moving said third conductive or insulating layer on said first conductive layer while irradiating the surface of said third conductive or insulating layer with an electron beam.

37. A method of directly laminating a first insulating material layer to a second insulating material layer comprising the steps of:
positioning said first insulating material layer on said second insulating material layer; and
irradiating the surface of said first insulating material layer with an electron beam; said electron beam penetrating through said first insulating material layer to the interface between said first insulating material layer and said second insulating material layer; and said electron beam bonding said first insulating material layer to said second insulating material layer at said interface.

38. The method of directly laminating a first insulating material layer to a second insulating material layer of claim 37 wherein said irradiating the surface of said first insulating material layer with an electron beam is irradiating the entire surface said first insulating material layer simultaneously with a large area electron beam.

39. The method of directly laminating a first insulating material layer to a second insulating material layer of claim 37 wherein said irradiating the surface of said first insulating material layer is with a point electron beam.

40. The method of directly laminating a first insulating material layer to a second insulating material layer of claim 37 wherein said irradiating the surface of said first insulating material layer is with a line electron beam.

41. The method of directly laminating a first insulating material layer to a second insulating material layer of claim 37 wherein said irradiating the surface of said first insulating material layer with an electron beam is irradiating the entire surface said first insulating material layer with a electron beam sweeping across the entire surface said first insulating material layer.

42. The method of directly laminating a first insulating material layer to a second insulating material layer of claim 37 wherein said first insulating material is a fluoropolymer and said second insulating material is a fluoropolymer.

43. The method of directly laminating a first insulating material layer to a second insulating material layer of claim 37 wherein said second insulating material is a porous insulator.

44. The method of directly laminating a first insulating material layer to a second insulating material layer of claim 37 wherein said first insulating material is the same as said second insulating material.

45. The method of directly laminating a first insulating material layer to a second insulating material layer of claim 37 wherein said irradiating with an electron beam is conducted in a soft vacuum environment.

46. The method of directly laminating a first insulating material layer to a second insulating material layer of claim 45 wherein said soft vacuum environment is between 5 and 80 milliTorr.

47. The method of directly laminating a first insulating material layer to a second insulating material layer of claim 37 wherein said irradiating with an electron beam is an electron energy between 1 and 50 keV.

48. The method of directly laminating a first insulating material layer to a second insulating material layer of claim 37 wherein said irradiating with an electron beam heats said first insulating material layer and said second insulating material layer accelerating and increasing said electron beam bonding said first insulating material layer to said second insulating material layer at said interface.

49. The method of directly laminating a first insulating material layer to a second insulating material layer of claim 37 further comprising the step of:
positioning an aperture mask between said electron beam and said first insulating material layer such that said electron beam selectively irradiates a portion of said surface of said first insulating material layer underneath said aperture in said mask; said electron beam penetrating through said first insulating material layer to the interface between said first insulating material layer and said second insulating material layer, and said electron beam selectively bonding said first insulating material layer to said second insulating material layer at said interface underneath said aperture in said mask.

50. The method of directly laminating a first insulating material layer to a second insulating material layer of claim 37 further comprising the step of:
moving said first insulating material layer on said second insulating material layer while irradiating the surface of said first insulating material layer with an electron beam.

51. The method of directly laminating a first insulating material layer to a second insulating material layer of claim 37 wherein said irradiating the surface of said first insulating material layer with an electron beam is selectively irradiating a portion of said surface of said first insulating material layer with an electron beam; said electron beam penetrating through said first insulating material layer to the interface between said first insulating material layer and said second insulating material layer, and said electron beam selectively bonding a portion of said first insulating material layer to said second insulating material layer at said interface.

52. The method of directly laminating a first insulating material layer to a second insulating material layer of claim 51 further comprising the step of:
removing the portion of said first insulating material layer not selectively irradiated by said electron beam and not selectively bonded to said second insulating material layer at said interface.

53. The method of directly laminating a first insulating material layer to a second insulating material layer of claim 37 further comprising the step of:
positioning a third conductive or insulating layer on said first insulating material layer; and
irradiating the surface of said third conductive or insulating layer with an electron beam; said electron beam penetrating through said third conductive or insulating layer to the interface between said third conductive or insulating layer and said first insulating material layer; and said electron beam bonding said third conductive or insulating layer to said first insulating material layer at said interface.

54. The method of directly laminating a first insulating material layer to a second insulating material layer of claim 53 further comprising the step of:
positioning an aperture mask between said electron beam and said third conductive or insulating layer such that said electron beam selectively irradiates a portion of said surface of said third conductive or insulating layer underneath said aperture in said mask; said electron beam penetrating through said third conductive or insulating layer to the interface between said third conductive or insulating layer and said first insulating layer, and said electron beam selectively bonding said third conductive or insulating layer to said first insulating layer at said interface underneath said aperture in said mask.

55. The method of directly laminating a first insulating material layer to a second insulating material layer of claim 53 further comprising the step of:
moving said third conductive or insulating layer on said first insulating layer while irradiating the surface of said third conductive or insulating layer with an electron beam.

56. An apparatus for directly laminating a first layer of a first material to a second layer of a second material comprising
a chamber wherein said first layer of said first material is positioned on said second layer of said second material; and
an electron beam exposure apparatus in said chamber for irradiating said first layer of a first material with an electron beam; said electron beam penetrating through said first layer of said first material to the interface between said first layer of said first material and said second layer of said second material, and said electron beam bonding said first layer of said first material to said second layer of said second material at said interface.

57. The apparatus for directly laminating a first layer of a first material to a second layer of a second material of claim 56 wherein said chamber is a vacuum chamber for providing a soft vacuum environment.

58. The apparatus for directly laminating a first layer of a first material to a second layer of a second material of claim 57 wherein said soft vacuum environment is between 5 and 80 milliTorr.

59. The apparatus for directly laminating a first layer of a first material to a second layer of a second material of claim 56 wherein said electron beam has an electron energy between 1 and 50 keV.

60. The apparatus for directly laminating a first layer of a first material to a second layer of a second material of claim 57 wherein said electron beam has an electron energy between 1 and 50 keV.

61. The apparatus for directly laminating a first layer of a first material to a second layer of a second material of claim 56 further comprising:
a ground electrode attached to said first layer of said first material for maintaining the first layer at or near ground potential.

62. The apparatus for directly laminating a first layer of a first material to a second layer of a second material of claim 56 wherein said electron beam heats said first layer of a first material and said second layer of said second material accelerating and increasing said electron beam bonding said first layer of said first material to said second layer of said second material at said interface.

63. The apparatus for directly laminating a first layer of a first material to a second layer of a second material of claim 56 further comprising:
a heating element for heating said second layer of said second material for accelerating and increasing said electron beam bonding said first layer of said first material to said second layer of said second material at said interface.

64. The apparatus for directly laminating a first layer of a first material to a second layer of a second material of claim 56 further comprising:
an aperture mask positioned between said electron beam and said first layer of said first material such that said electron beam selectively irradiates a portion of said surface of said first layer of said first material underneath said aperture in said mask; said electron beam penetrating through said first layer of said first material to the interface between said first layer of said first material and said second layer of said second material, and said electron beam selectively bonding said first layer of said first material to said second layer of said second material at said interface underneath said aperture in said mask.

65. The apparatus for directly laminating a first layer of a first material to a second layer of a second material of claim 57 further comprising:
an aperture mask positioned between said electron beam and said first layer of said first material such that said electron beam selectively irradiates a portion of said surface of said first layer of said first material underneath said aperture in said mask; said electron beam penetrating through said first layer of said first material to the interface between said first layer of said first material and said second layer of said second material, and said electron beam selectively bonding said first layer of said first material to said second layer of said second material at said interface underneath said aperture in said mask.

66. The apparatus for directly laminating a first layer of a first material to a second layer of a second material of claim 56 further comprising:
means for moving said first layer of said first material on said second layer of said second material while said electron beam exposure apparatus irradiates said first layer of said first material with an electron beam.

67. The apparatus for directly laminating a first layer of a first material to a second layer of a second material of claim 57 further comprising:
means for moving said first layer of said first material on said second layer of said second material while said electron beam exposure apparatus irradiates said first layer of said first material with an electron beam.

68. The apparatus for directly laminating a first layer of a first material to a second layer of a second material of claim 56 wherein said first material is different from said second material.

69. The apparatus for directly laminating a first layer of a first material to a second layer of a second material of claim 56 wherein said first material is a conductive material and said second material is an insulating material.

70. The apparatus for directly laminating a first layer of a first material to a second layer of a second material of claim 56 wherein said first material is a metal and said second material is a fluoropolymer.

71. The apparatus for directly laminating a first layer of a first material to a second layer of a second material of claim 56 wherein said first material is the same as said second material.

72. The apparatus for directly laminating a first layer of a first material to a second layer of a second material of claim 56 wherein said first material is an insulating material and said second material is an insulating material.

73. The apparatus for directly laminating a first layer of a first material to a second layer of a second material of claim 56 wherein said electron beam apparatus selectively irradiates a portion of said surface of said first layer of said first material with an electron beam; said electron beam penetrating through said first layer of said first material to the interface between said first layer of said first material and said second layer of said second material; and said electron beam selectively bonding a portion said first layer of said first material to said second layer of said second material at said interface.

74. The apparatus for directly laminating a first layer of a first material to a second layer of a second material of claim 73 further comprising
means to remove the portion of said first layer of said first material not selectively irradiated by said electron beam and not selectively bonded to said second layer of said second material at said interface.

75. An apparatus for directly laminating multiple conductive or insulating layers comprising
a chamber wherein said multiple conductive or insulating layers are positioned on each other; and
an electron beam exposure apparatus in said chamber for irradiating each of the multiple conductive or insulating layers with an electron beam; said electron beam penetrating through each of the multiple conductive or insulating layers to the interface with the adjacent multiple conductive or insulating layers, and said electron beam bonding each of the multiple conductive or insulating layers to the adjacent multiple conductive or insulating layers at said interface.

76. The apparatus for directly laminating multiple conductive or insulating layers of claim 75 wherein said chamber is a vacuum chamber for providing a soft vacuum environment.

77. The apparatus for directly laminating multiple conductive or insulating layers of claim 75 further comprising:
an aperture mask positioned between said electron beam and said multiple conductive or insulating layers such that said electron beam selectively irradiates a portion of said surface of said multiple conductive or insulating layers underneath said aperture in said mask; said electron beam penetrating through said multiple conductive or insulating layers to the interface between at least one of the multiple conductive or insulating layers to the interface with the adjacent multiple conductive or insulating layer, and said electron beam selectively bonding said at least one of the multiple conductive or insulating layers to the adjacent multiple conductive or insulating layer at said interface.

78. The apparatus for directly laminating multiple conductive or insulating layers of claim 75 further comprising:
means for moving multiple conductive or insulating layers while said electron beam exposure apparatus irradiates said multiple conductive or insulating layers with an electron beam.

79. A laminate comprising
a metal layer having a first surface and a second surface, said second surface being opposite said first surface; and
a fluoropolymer layer having a first surface and a second surface, said second surface being opposite said first surface; wherein said second surface of said metal layer is directly laminated to said first surface of said fluropolymer layer.

80. An optical reflective element comprising
a metal layer having a first surface and a second surface, said second surface being opposite said first surface; and
a fluoropolymer layer having a first surface and a second surface, said second surface being opposite said first surface; wherein said second surface of said metal layer is directly laminated to said first surface of said fluropolymer layer.

81. A circuit board comprising
a conductive metal layer having a first surface and a second surface, said second surface being opposite said first surface; and
an insulating fluoropolymer layer having a first surface and a second surface, said second surface being opposite said first surface; wherein said second surface of said conductive metal layer is directly laminated to said first surface of said insulating fluropolymer layer.
